(19) United States
(12) Patent Application Publication
(10) Pub. No.: US 2016/0178335 A1
(43) Pub. Date: Jun. 23, 2016

(54) Projectile and Missile Enhancement and Drag Reduction Technology

(71) Applicant: Jacob Tullis Lister, Round Mountain, NV (US)

(72) Inventor: Jacob Tullis Lister, Round Mountain, NV (US)

(21) Appl. No.: 14/580,106

(22) Filed: Dec. 22, 2014

(51) Int. Cl. F42B 10/38; B64C 21/10

(52) U.S. Cl. CPC F42B 10/38; B64C 21/10

(57) ABSTRACT

A bullet for a rifle, an artillery shell, or even a missile is all subject to drag. The vacuum created as air moving at high speed passes over the end or past any change of angle of a projectile or missile slows the projectile or missile. Placing dimples or depressions, or the inverse thereof, around the circumference and or along the length of a bullet to create vortices to disrupt the air flow will fill the area where partial vacuums form with air. The streamlined boat tail bullet design, as an example, reduces this form drag by allowing the air to flow along the surface of the tapering end. The resulting aerodynamic advantage is currently seen as the optimum shape for rifle technology. This invention will also further reduce drag and increase range, velocity, and trajectory.

This drag reduction and/or range enhancement technology is achieved by the addition of shallow holes or dimples in the surface of the projectile as in the case of a rifle slug, artillery round, rocket, or missile, etc. Or the addition of bumps to the exterior of missiles, rockets, artillery rounds, etc. To create vortices to direct air currents to areas where partial vacuums are formed during the flight of the object, reducing drag and increasing range and flight time.

### SPECIFICATION

This invention involves adding dimples to the surface of the projectile or a missile surface. Missiles, rockets, etc. may also use the inverse of dimples. One example is U.S. Pat. No. 5,737,757, which discusses making dimples using two different spherical radii with an inflection point where the two curves meet. In most cases, however, the cross-sectional profiles of dimples in prior art golf balls are parabolic curves, ellipses, semi-spherical curves, saucer-shaped, a sine curve, a truncated cone, a flattened trapezoid or the catenary curve.

The dimples or depressions or the inverse thereof can be created by drilling, swedging, mechanical deformation, or the addition of materials to the exposed surface. The size of such dimples or the inverse thereof varies in relationship to the size of the projectile or missile and the size of the vortex needed to prevent drag. Differences in size, shape, and velocity of the projectile or missile require different dimples or the inverse thereof.

The present invention is not limited by any particular dimple pattern. Examples of suitable dimple patterns include, but are not limited to, phyllotaxis-based patterns; polyhedron-based patterns; and patterns based on multiple copies of one or more irregular domain(s) as disclosed in U.S. Pat. No. 8,029,388, the entire disclosure of which is hereby incorporated herein by reference; and particularly dimple patterns suitable for packing dimples on seamless golf balls. Non-limiting examples of suitable dimple patterns that are applicable to projectiles and or missiles are further disclosed in U.S. Pat. Nos. 7,927,234, 7,887,439, 7,503,856, 7,258,632, 7,179,178, 6,969,327, 6,702,696, 6,699,143, 6,533,684, 6,338,684, 5,842,937, 5,562,552, 5,575,477, 5,957,787, 5,249,804, 5,060,953, 4,960,283, and 4,925,193, and U.S. Publication Nos. 2006/0025245, 2011/0021292, 2011/0165968, and 2011/0183778, the entire disclosures of which are hereby incorporated herein by reference.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

### PATENT CITATIONS

None found relating to this use.

Projectile and Missile Enhancement and Drag Reduction Technology

### DRAWINGS

Non-applicable.

1. By the use of this projectile and missile enhancement and drag reduction technology the flight time is increased and therefore the range of a projectile is enhanced.

2. By the use of this projectile and missile enhancement and drag reduction technology the amount of energy to travel a particular distance, as in the case of a missile, rocket, or projectile, etc. is reduced.
